(19) United States
(12) Patent Application Publication
(10) Pub. No.: US 2004/0049960 A1
(43) Pub. Date: Mar. 18, 2004

(54) Remote controlled advertising system

(76) Inventor: Kelly C. Percy, Revere, MA (US)

Correspondence Address: HALE & DORR LLP, THE WILLARD OFFICE BUILDING, 1455 PENNSYLVANIA AVE, NW, WASHINGTON, DC, 20004, US

(21) Appl. No.: 10/207,828

(22) Filed: Jul. 31, 2002

(51) Int. Cl. G06F 17/60; G09G 3/00; G09F 21/04

(52) U.S. Cl. 40/590; 705/14

(57) ABSTRACT

An advertisement system allows display of at least one product advertisement. The system includes a base, an advertisement display unit, a motor, and a receiver. The receiver receives input signals from a control unit that is remotely located, and converts the input signals into control signals that control operation of the motor and advertisement display unit. A power source can be mounted on the base to supply power to the system.

### BACKGROUND OF THE INVENTION

1. Technical Field

The present invention relates to advertising and, more particularly, to an advertising system that is mobile and remotely controllable, for example, by an operator.

2. Description of the Related Art

Advertising represents a significant factor in influencing consumer purchases. Each year, businesses spend millions of dollars in product advertising in order to assert and/or reinforce brand recognition, and also to educate the public. Ultimately, businesses rely on advertisements to lure and/or maintain consumers who purchase their products. For example, one method of gaining consumer spending relies on a high level of name (or brand) exposure to the consumer by a business to create a sense of security, and convince users to purchase products bearing a familiar name rather than generic versions of similar products from companies without such name recognition.

Advertisements are often presented in the form of billboards, printed promotions, radio and television commercials, and electronic displays. However, significant research must first be conducted to develop advertisements that effectively coordinate the state of mind and awareness levels with timing of consumer exposure to company and product names. For example, audio and visual promotions are often played within a store where consumers are already engaged in a selection process for products under numerous brand names. The high level of awareness and attention of the mind when involved in the decision-making process enhances the susceptibility to direct and indirect influence of advertising messages. Therefore, such an audio jingle or broadcast sale promotion would tend to sway purchasing decisions when the consumer is involved in the decision-making process. Aisle advertising is very popular because it places promotional materials directly in front of the consumer at the very location where a purchase decision will be made.

Other circumstances also tend to stimulate increased consumer attention to product source and identity issues. For example, point of purchase and cash register display advertising are intended to catch consumers when they are in the very act of paying for a product or service. The slightest interest in the advertised product would tend to illicit purchase of the item. At this stage, the customer has made at least one purchasing decision, including selection of a specific brand or company product. Thus, they have already committed to spending. The act of payment operates to place value on the decision (including the company name or brand), and is typically reinforcing a frame of mind in which the consumer is reviewing the benefits of the purchase. It naturally follows that the point of purchase can possibly enhance sensitivity to advertising influence.

Effective advertising can also involve strategic placement of billboards and other large displays that can be seen by consumers outside of shopping areas. Most large billboards are strategically placed alongside highways and major roads. The billboards can display advertisements that reinforce brand recognition, or identify the location and/or availability of certain goods and products. Advertisements are currently being displayed on mobile structures such as trucks, vans, and taxis. Because of their mobile nature, such advertisements are typically intended to reinforce brand recognition as they are viewed, in passing, by consumers.

However, current advertising systems do not provide an ability to promote products when consumers are in the vicinity of shopping establishments that necessarily carry those products. For example, most advertisements are viewed by consumers while driving or watching television. These advertisements tend to reinforce brand recognition or identify brands and/or products that consumers may consider purchasing in the future. Since the consumer may not always be in a position to immediately go out and purchase the advertised product, the consumer is likely to forget about the product unless the advertisement is repeated. Other forms of advertising, for example, involve the display of product advertisements to the consumer within the aisle of a shopping area. These advertisements can be effective for swaying consumers to purchase the advertised product. However, such advertisements are limited to products that can be purchased within the particular store that the consumer is shopping. In addition, this type of advertising relies on the consumers predisposition to engage in the purchase of one or more predetermined items. Consequently, these items are not effective for swaying a consumer on the street to enter a store and purchase the advertised item.

There currently exist various advertising methods and arrangements that are intended to increase consumer purchase of advertised goods. For example, U.S. Pat. Nos. 4,782,615; 5,210,969; 5,507,109; 5,703,564; 5,918,924; 5,992,888; and 6,282,822 (all of which are incorporated herein by reference), all disclose various systems and arrangements for presenting advertisements to consumers. These systems, however, are unable to effectively provide advertisements within the proximity of a store for purposes of attracting a consumer's attention and invoking purchase of the advertised product.

Accordingly, there exists a need for an advertising system capable of displaying advertisements to consumers who are currently within the proximity of a store selling the advertised product. There also exists a need for an advertising system that is mobile within the vicinity of one or more stores where advertised products can be purchased. There also exists a need for an advertising system that is mobile and capable of displaying advertisements for different products at predetermined time intervals.

### SUMMARY OF THE INVENTION

It is therefore one feature and advantage of the present invention to address at least some of the shortcomings of the prior art in effectively displaying advertisements to consumers.

It is another optional feature and advantage of the present invention to provide an advertising system capable of displaying advertisements to consumers who are currently within the proximity of a store selling the advertised product.

It is another optional feature and advantage of the present invention to provide an advertising system that is mobile within the vicinity of one or more stores where advertised products can be purchased.

The foregoing, and various other needs, are addressed, at least in part, by the present invention, wherein a mobile advertising system includes an advertisement display unit mounted on a movable base that can be remotely controlled in various directions and to display various product advertisements.

According to one aspect of the present invention, a mobile advertising system comprises a base, an advertisement display unit, a motor, and a receiver. The advertisement display unit is mounted on the base and carries at least one product advertisement thereon. The motor is operatively coupled to the base for moving the mobile advertising system. The receiver is also mounted on the base and operatively coupled to the motor. The receiver receives input signals from a remote source and converts the input signals into control signals that control operation of the motor. A power source can be mounted on the base to supply power to the mobile advertising system. The receiver is controlled by a control unit that is remotely located from the mobile advertising system. According to such a system, advertisements can be effectively presented to consumers. For example, the mobile nature of the system functions, in part, to attract consumer attention. The advertisement display unit provides advertisement for at least one product that can be purchased at a store within the proximity of mobile advertising system. Thus, once consumer's attention is gained, the advertised product can be purchased at a store that is only a few steps away from the consumer. Furthermore, the risk of forgetting the advertised product can be eliminated, or at least minimized, because the consumer would be persuaded to purchase the product immediately.

According to one optional aspect of the invention, the receiver can be made compatible with at least one telephone network. Furthermore, the input signals can be received across the telephone network after a connection has been established with the receiver. Thus, an operator (or user) would be required to know a specific telephone number that would establish a connection to the receiver, thereby allowing transmission of the input signals and control of the mobile advertising system. Further options include the use of either a conventional circuit switched telephone network or a wireless telephone/communication network. Such flexibility allows potential operation in many different types of locations as well as the benefit of access to established communication channels.

According to another optional aspect of the invention, the control unit is in the form of a mobile communication device that is compatible with the telephone network. The mobile communication device can be used to establish a communication channel with the receiver and transmit the input signals. The mobile communication device can optionally be in the form of a wireless telephone, thus providing an ability to initiate establishment of the communication channel. The mobile communication device can also be in the form of personal digital assistant (PDA) having appropriate hardware (e.g., a wireless modem) for establishing the communication channel. As an additional option, the control unit can be in the form of a conventional radio controller (R/C) device transmitting input signals along a radio frequency (RF) channel. Furthermore, the control unit can be in the form of a radio controller that is concealed within the housing of a conventional mobile telephone while operating on an RF channel. Such options for the control unit allow flexibility and stealth to the operator. For example, if the control unit is in the form of a mobile telephone, the operator can pretend to be engaged in a conversation using and/or operation of the mobile telephone, thus further intriguing the consumer. Likewise, a PDA would leave consumers to wonder who is controlling the mobile advertising system.

According to another optional aspect of the invention, the receiver can include a CPU (and/or controller), a memory, and data storage device. The CPU controls operation of the mobile advertising system, including the advertising display unit. The data storage device can be used to store data corresponding to one or more advertisements. For example, each advertisement can be represented as a saved data file. The CPU controls retrieval of specific data files responsive to input commands received from the user. The CPU loads the data file into the memory and processes the data file into an appropriate output corresponding to the advertisement. The data is then transmitted to the advertisement display unit. A further option provides an advertisement display unit that includes a video controller and display screen. The video controller receives the processed data file from the CPU and controls the output of the display screen. According to such an arrangement, multiple advertisements can be stored in the data storage device for selective retrieval and display. Furthermore, the mobile advertising unit can be configured for movement within the proximity of multiple stores while displaying an advertisement appropriate to each specific store when in the proximity of such a store.

There has thus been outlined, rather broadly, the more important features of the invention and several, but not all, embodiments in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

These, together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

FIG. 1 is a perspective view of a mobile advertising system according to an exemplary embodiment of the present invention;

FIG. 2 is a bottom plan view of the base of the mobile advertising system;

FIG. 3 is a side elevational view of the base showing the advertisement display unit; and

FIG. 4 is a block diagram illustrating an exemplary embodiment for controlling the content and operation of the advertisement display unit.

### DETAILED DESCRIPTION OF THE INVENTION

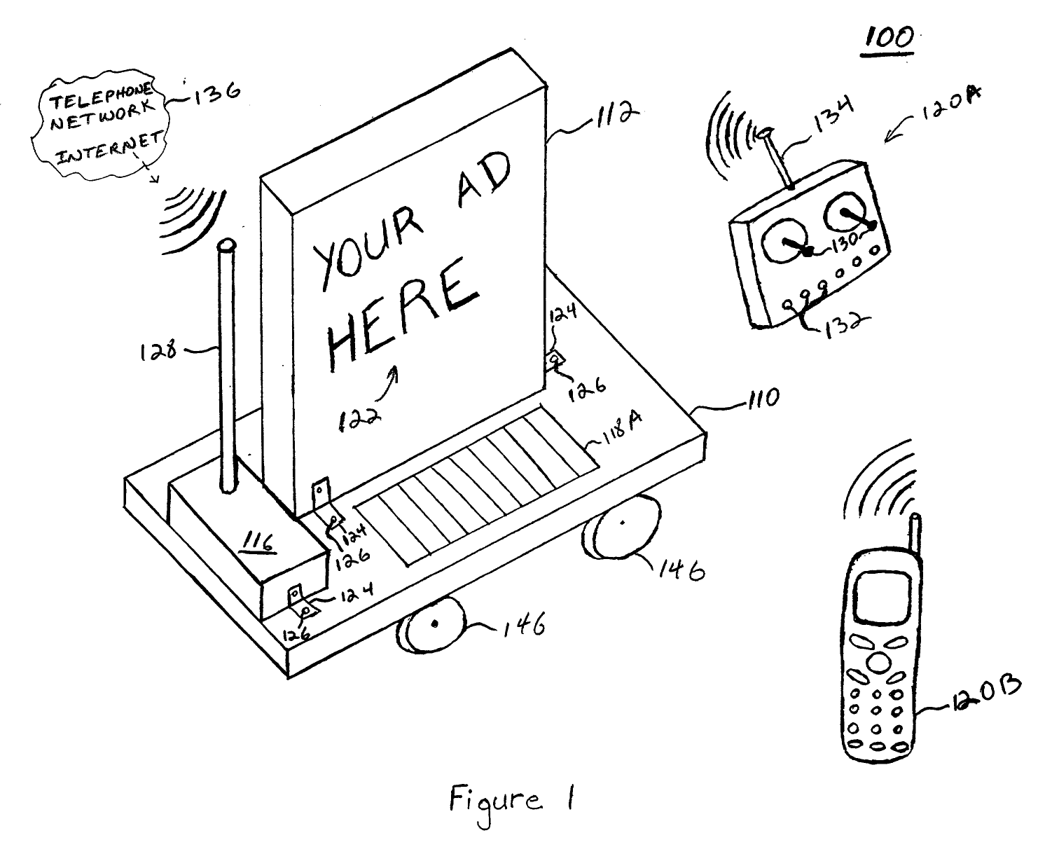

Turning now to the drawings, and initially to FIG. 1, there is shown (and generally referenced by the numeral 100) a mobile advertising system constructed in accordance with the present invention. The mobile advertising system 100 includes a base 110, an advertisement display unit 112, a motor 114, a receiver 116, a power source 118, and a control unit 120. As illustrated in FIG. 1, the base 110 is in the form of a platform or support structure upon which the remaining components are mounted. The base 110 can be constructed from various materials including, for example, plastic, wood, aluminum, etc. Preferably, the base 110 is designed such that it is capable of safely supporting all of the components of the mobile advertising system 100, while being lightweight. The advertisement display unit 112 is mounted on the base 110 and occupies a focal point of the mobile advertising system 100. More particularly, the advertisement display unit 112 is intended to carry, or display, at least one product advertisement 122, as shown in FIG. 1.

Depending on the specific construction of the mobile advertising system 100, the advertisement display unit 112 can be configured to display animated or dynamic types of product advertisements 122. The advertisement display unit 112 can also be configured to simply carry one or more billboards or stationary types of product advertisements. Furthermore, various methods and devices can be used to secure the advertisement display unit 112 to the base 110. As illustrated in FIG. 1, a plurality of mounting brackets 124 and fasteners 126 are used to secure the advertisement display unit 112 to the base 110. Alternatively, adhesive-type fasteners could be used to secure the advertisement display unit 112 to the base 110. Furthermore, the base 110 can be constructed such that it incorporates a channel therein (not shown) for receiving the advertisement display unit 112 in a mating fashion (e.g., configured to mate with each other) that can securely retain the advertisement display unit 112.

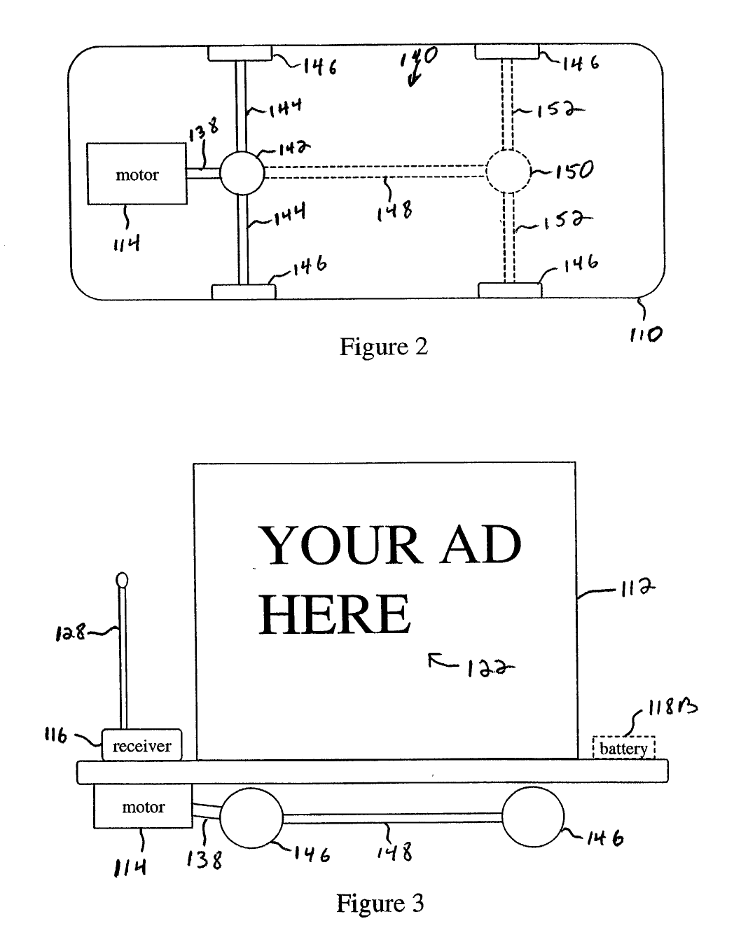

With continued reference to FIG. 1, and additional reference to FIG. 2, the mobile advertising system 100 also includes a motor 114 that is operatively coupled to the base 110. The motor 114 is constructed and arranged such that it is capable of imparting motion to the mobile advertising system. The mobile advertising system 110 also includes a receiver 116 that is mounted on the base 110. Similar to the advertisement display unit 112, the exemplary embodiment of the invention illustrated in FIG. 1 utilizes an arrangement of mounting brackets 124 and fasteners 126 to secure the receiver 116 to the base 110. Again, various other arrangements can be used depending on preference and design requirements. In addition, the receiver can be operatively coupled to the motor in order to control its operation. The receiver includes an antenna 128 which facilitates reception of input signals from a remote source. The input signals are subsequently converted into control signals that can be used to control the operation of either the motor 114, the advertisement display unit 112, or both.

The power source 118 is mounted to the base 110 and selected such as is capable of providing sufficient power to the receiver 116, the motor 114, and the advertisement display unit 112 (if necessary). Depending on the specific design of the mobile advertising system 100, the power source 118 can take on various configurations. As illustrated in FIG. 1, for example, the power source 118 can optionally be in the form of solar panels 118A that are capable of converting solar (or radiant) energy into electricity. FIG. 2, however, illustrates a configuration wherein the power source 118 is in the form of batteries 118B. In such a configuration, the batteries 118B can be in the form of conventional or rechargeable batteries (e.g., conventional alkaline, nickel-metal hydride, rechargeable nickel cadmium, etc.).

The mobile advertising system 100 is controllable by means of a control unit 120 that is remotely located from the receiver. Preferably, the control unit 120 is in the possession (or control) of an operator (not shown) responsible for controlling operation of the mobile advertising system 100. The control unit 120 transmits input signals corresponding to one or more input signals from the operator. As previously indicated, the input signals are received by the receiver 116 and converted into control signals that operate the motor 114 and/or the advertisement display unit 112.

As illustrated in FIG. 1, the control unit 120 can take various forms. One embodiment of the present invention provides for a control unit 120 that is in the form of a conventional radio control (R/C) transmitter 120A. As is well known, such R/C transmitters can include one or more stick controllers 130 capable of transmitting analog (or proportionate) directional signals and/or multiple buttons 132 that correspond to specific commands and/or features. The R/C transmitter 120A also includes an antenna 132 which facilitates transmission of input signals that correspond to actions requested by the user. When the input signals are received by the receiver 116, they are converted into appropriate control signals that cause operation of the mobile advertising system 100. Although the exemplary embodiment illustrated in the Figures shows only a single motor for controlling movement of the mobile advertising system 100, it should be noted that there are various options available for performing this task. For example, an R/C transmitter in conjunction with the receiver 116 can be configured to include one or more servos (not shown) that can be used to control output of the motor 114, thus corresponding to the velocity of the mobile advertising system 100. The servos can also be coupled to the wheels in order to control the direction of travel of the mobile advertising system 100.

Another embodiment of the present invention configures a mobile telephone 120B as the control unit 120. According to such an embodiment, the receiver 116 would be configured for compatibility with at least one telephone network 136. Thus, the mobile telephone 120B would be used to establish a connection with the receiver 116 across a communication channel and transmit the input signals across the telephone network 136. Furthermore, the telephone network 136 can be either conventional, wired circuit switched networks, or can optionally be a wireless telephone network. The telephone network can also be in the form of a hybrid system such as a packet-switch voice network, optical network, etc. According to another embodiment of the invention, the control unit 120 can optionally be in the form of a personal digital assistant (PDA). Such a configuration, however, necessarily requires that the PDA be configured for either transmitting the appropriate input signals along a common channel that can be received by the receiver 116. The PDA can also be provided with appropriate communication hardware for accessing the telephone network 136 to establish a communication channel with the receiver 116.

According to yet another embodiment of the present invention, the control unit 116 can be in the form of a conventional radio frequency (RF) transmitter that is concealed within the casing of a mobile telephone unit. According to such an arrangement, the keys of the mobile telephone would correspond to predetermined input signals that would be transmitted to the receiver 116. For example, one key of the mobile telephone casing can correspond to activation of the advertisement display unit 112. Another key can correspond to an increase in acceleration of the motor 114, with another key corresponding to a decrease in acceleration of the motor 114. Similarly, a pair of keys can be programmed to control the direction (e.g., left and right) of the mobile advertising system 100.

Referring to FIGS. 2 and 3, additional details of the mobile advertising system 100 will now be described. The disclosed embodiment of the invention is illustrated as providing a motor having an output shaft 138 that is operatively coupled to a drivetrain 140. The drivetrain 140 can include, for example, an appropriate differential unit 142 that receives power coupled to the output shaft 138 for transferring power to a pair of individual front drive shafts 144. The front drive shafts 144 are in turn attached to a pair of wheels 146 in order to control movement of the mobile advertising system 100. According to an optional embodiment of the present invention, the differential unit 142 can optionally be coupled to a secondary output shaft 148. The secondary output shaft 148 is in turn connected to a rear differential unit 150 that transmits power to the rear wheels by means of a pair of rear drive shafts 152.

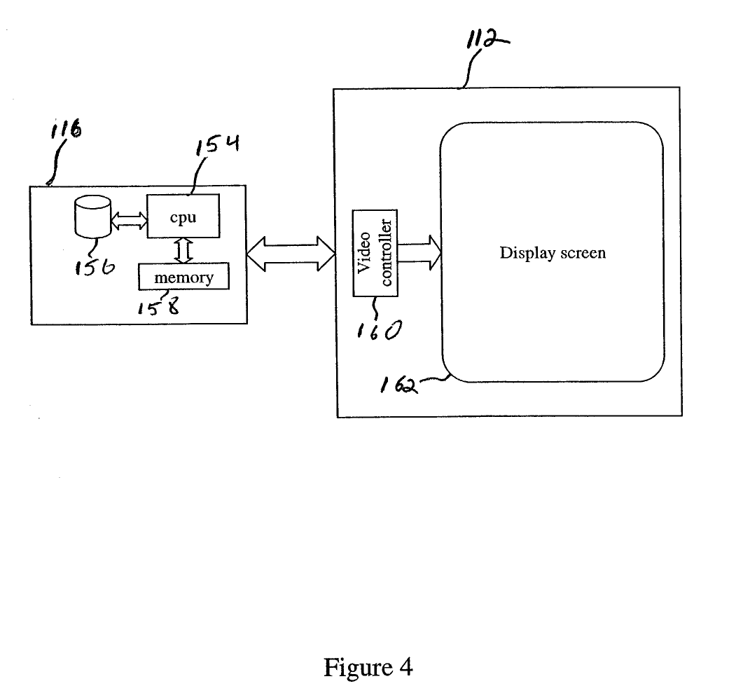

FIG. 4 illustrates an optional configuration for controlling the content and operation of the advertisement display unit 100. In particular, the arrangement of FIG. 4 is suited for configuring the advertisement display unit as a active display system such as a video monitor, fiber optic board, LED display, etc. which is capable of carrying dynamic or moving product advertisements 122. As illustrated in FIG. 4, the receiver 116 is configured to include a CPU/controller 154, a data storage device 156, and a memory 158. The data storage 156 device is used to store a plurality of data files that correspond to predetermined product advertisements 122. More particularly, the data files contain information that can be interpreted to correspond to product advertisements 122 that can be displayed on the advertisement display unit 100. The CPU 154 thus functions to control the mobile advertising system 100 and/or the advertisement display unit 112.

In operation, the CPU 154 would retrieve data files from the data storage device 156 in response to input signals received from the control unit 120. For example, consider a situation where five different data files are stored on the data storage device 156. The operator can transmit an appropriate input signal to cause the CPU 154 to access a specific data file either dynamically or sequentially. Dynamic access would allow the CPU 154 to retrieve the data file using a single command, while sequential access would require that the CPU 154 retrieve each data file in sequential order until the operator is satisfied with the data file that has been loaded. The data storage device 156 can be in the form of either nonvolatile memory or magnetic storage media. Once the CPU 154 retrieves the data file from the data storage device 156, the data file is processed for display on the advertisement display unit 112.

As illustrated in FIG. 4, a memory 158, such as a random access memory (RAM), can be used by the CPU 154 while the data files are being processed. Once the data file is processed, the information is transmitted to the advertisement display unit 112. As further illustrated in FIG. 4, an exemplary embodiment of the advertisement display unit 112 provides for a video controller 160 that is coupled to a display screen 162. The video controller 160 receives the processed data from the CPU 154 and optionally performs additional manipulation to optimize output of the display screen 162. Furthermore, the video controller 160 can be configured to control the manner in which the information is presented on the display screen 162 optionally, video memory, or fast memory (not shown) can be used in by the video controller 160 to optimize data access.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A mobile advertising system comprising:
a base;
an advertisement display unit mounted on said base, said advertising display unit carrying at least one product advertisement thereon;
a motor operatively coupled to said base, said motor being capable of moving the mobile advertising system;
a receiver mounted on said base and operatively coupled to said motor, said receiver receiving input signals from a remote source and converting said input signals into control signals for controlling operation of said motor;
a power source mounted on said base and supplying power to the mobile advertising system; and
a control unit remotely located from the mobile advertising system for transmitting said input signals to said receiver, said input signals corresponding one or more user commands.

2. The mobile advertising system of claim 1, further comprising a drivetrain operatively coupled to said motor for transferring output of said motor to a drive unit for moving the mobile advertising system.

3. The mobile advertising system of claim 1, wherein said receiver is compatible with at least one telephone network and receives said input signals across one of said compatible telephone networks after a connection has been established.

4. The mobile advertising system of claim 5, wherein said telephone network is a circuit switched telephone network.

5. The mobile advertising system of claim 3, wherein said telephone network is a wireless telephone network.

6. The mobile advertising system of claim 3, wherein said control unit comprises a mobile communication device compatible with said at least one telephone network, said mobile communication device being capable of establishing a communication channel with said receiver and transmitting said input signals across said at least one telephone network.

7. The mobile advertising system of claim 6, wherein said mobile communication device comprises a personal digital assistant (PDA).

8. The mobile advertising system of claim 6, wherein said mobile communication device comprises a wireless telephone.

9. The mobile advertising system of claim 1, wherein said control unit comprises a radio controlled (R/C) transmitter.

10. The mobile advertising system of claim 1, further comprising a mobile telephone housing adapted to conceal said transmitter.

11. The mobile advertising system of claim 1, wherein said power source comprises one or more batteries.

12. The mobile advertising system of claim 1, wherein said power source comprises one or more solar panels.

13. The mobile advertising system of claim 1, wherein said advertisement display unit comprises at least one of a billboard, a fiber optic display system, and a video monitor.

14. The mobile advertising system of claim 1, wherein said advertising display unit includes:
a display screen for displaying said at least one product advertisement; and
a video controller for controlling the operation and output of said display screen.

15. The mobile advertising system of claim 1, wherein said receiver includes:
a data storage device for storing a plurality of data files, each of said data files corresponding to an advertisement;
a CPU/controller for controlling operation of mobile advertising system, said CPU/controller being configured to retrieve data files from said data storage device responsive to said input signals received from the user, said CPU/controller further processing said retrieved data files for display on said advertisement display unit; and
a memory for receiving and storing information from said CPU/controller while said CPU/controller processes said data files.

16. A method of displaying advertisements comprising the steps of:
constructing a mobile advertising system;
storing a plurality of data files corresponding to advertisements in a data storage device of the mobile advertising system;
selectively retrieving one or more data files from the data storage device;
displaying one or more retrieved data files on an advertisement display unit of the mobile advertising system; and
controlling movement of the mobile advertising system from a remote location.
